(19) United States
(12) Patent Application Publication
(10) Pub. No.: US 2002/0124744 A1
(43) Pub. Date: Sep. 12, 2002

(54) Method and apparatus for spot coating on printing substrates in large size printing machines

(76) Inventor: Jurgen Veil, Dresden (DE)

Correspondence Address: GOODWIN PROCTER & HOAR LLP, 7 BECKER FARM RD, ROSELAND, NJ, 07068, US

(21) Appl. No.: 09/993,236

(22) Filed: Nov. 14, 2001

(30) Foreign Application Priority Data
Nov. 16, 2000 (DE) 100 57 641.9

(51) Int. Cl. B41F 5/16; B41F 7/02

(52) U.S. Cl. 101/217; 101/183

(57) ABSTRACT

The invention relates to a method and apparatus for spot coating on printing substrates in large size printing machines producing a printed image by application of an ink layer on a printing substrate.

Task of the invention is to establish a method for spot coating of printing substrates also applicable in large size printing presses.

The task is solved according to the invention by coating of the entire area of the printed image by an universally applicable offset plate, using a coating reacting with the ink layer of at least two ink systems and changing the printed image so that diverging areas of gloss degree are created and by using a conventional printing press comprising of at least two printing units for printing of at least two ink systems, an optional dryer allocated to the printing units, and a coating unit for application of the final coating layer succeeding the printing units.

### FIELD OF INVENTION

The invention relates to a method and apparatus for spot coating on printing substrates in large size printing machines producing a printed image by application of an ink layer on a printing substrate.

### BACKGROUND OF INVENTION

Spot coating on surfaces of printing substrates is usually made by printing plates, which are especially copied for this purpose. These printing plates have partial recesses. This solution is described in the 9^{th} edition of the book “Offsetdrucktechnik” (Offset printing) by Helmut Teschner on page 11 to 43. This solution is not applicable for large size printing presses because the coating plates can not be manufactured in sufficient quality at this plate dimensions.

### SUMMARY DESCRIPTION OF INVENTION

Task of the invention is to establish a method for spot coating of printing substrates also applicable in large size printing presses.

The task is solved according to the invention by coating of the entire area of the printed image by an universally applicable offset plate, using a coating reacting with the ink layer of at least two ink systems and changing the printed image so that diverging areas of gloss degree are created and by using a conventional printing press comprising of at least two printing units for printing of at least two ink systems, an optional dryer allocated to the printing units, and a coating unit for application of the final coating layer succeeding the printing units.

The invention has the advantage, that varying degrees of gloss can be produced with only a single coating plate without partial recesses. The manufacturing costs for the coating plate is decreased extremely. The coating plate can now be used for several printing jobs so that the make ready time is reduced. Furthermore only one coating unit or coating tower is required.

### BRIEF DESCRIPTION OF THE DRAWINGS

The invention is described below in greater detail by an embodiment of the invention, by reference being had to the drawing, wherein:

FIG. 1: Schematic of a sheet fed offset press in unitized design.

### DETAILED DESCRIPTION

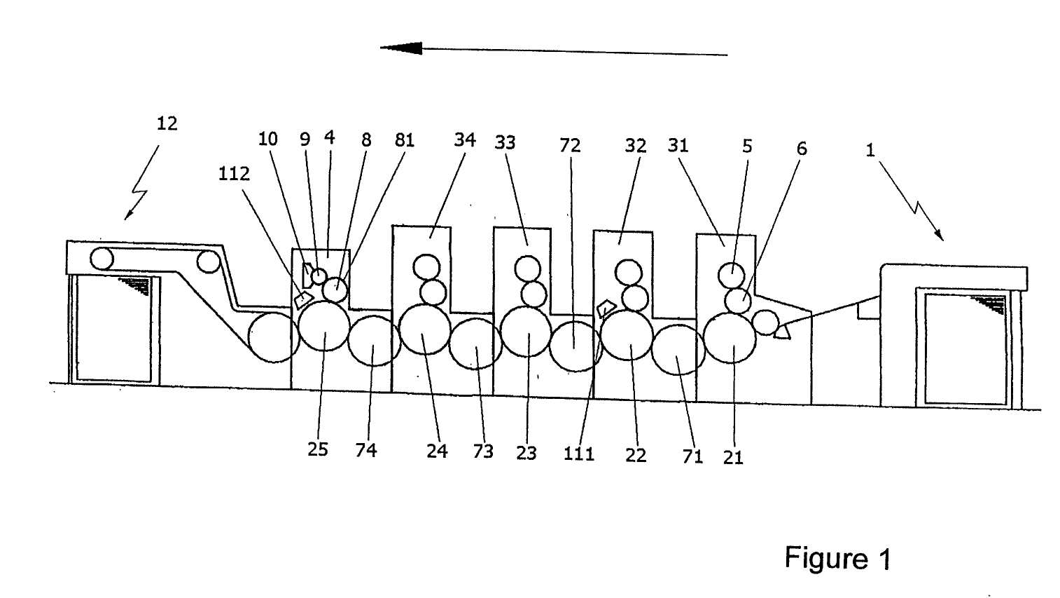

The sheet fed offset press in FIG. 1 has multiple printing units 31 to 34 arranged in unitized design. The embodiment shows four printing units 31 to 34 as an example. At least two printing units are required for the method according to the invention.

A feeder 1 precedes the printing units 31 to 34. Structure and function of the feeder 1 are known and will not be described here. Each of the printing units 31 to 34 has an impression cylinder 21 to 24, a plate cylinder 5 and a blanket cylinder 6. Plate cylinder 5 and blanket cylinder 6 are only denoted in the printing unit 31. The sheet travel direction is marked with an arrow. FIG. 1 shows also the transfer drums 71 to 74 located between two impression cylinders 21 to 25. The transfer drums 71 to 74 can also be embodied as perfecting drums. The impression cylinders 21 to 24 and the transfer drums 71 to 74 are sheet guiding cylinders of double diameter. The inking and dampening units allocated to each printing unit 31 to 34 are not shown in FIG. 1.

The shown printing units 31 and 32 are printing with an ink system containing inks constituents drying under radiation, normally ultraviolet radiation. The printing units 33 and 34 are printing with typical offset ink.

In the embodiment a dryer 111 is allocated to the printing unit 32. The dryer 111 must be selected for drying of the ink system, which is in this case an ultraviolet (UV) dryer.

A coating tower 4 follows the printing units 31 to 34 in the direction of the sheet travel. It has a coating form cylinder 8 allocated to the impression cylinder 25. The coating form cylinder 8 carries the coating plate 81. The coating tower 8 coats the printing image with a coating layer, which is also drying under radiation.

A screened roller 9 is allocated to the coating form cylinder 8 respectively the coating plate 81. The screened roller 9 is equipped with a chamber doctor blade 10 for coating supply. A dryer 112 is allocated to the coating tower 4.

The coating tower 4 is followed by the delivery 12. Structure and function of the delivery 12 are known and will not be described here.

This apparatus can realize the following method according to the invention:

The printing sheet is supplied by the feeder 1 and forwarded by not described means to the sheet travel. The ink of an ink system is applied in the printing units 31 to 32 through the blanket cylinder 6. The ink system contains proportional ink hardening under radiation, in the embodiment under ultraviolet radiation. These inks are denoted as hybrid ink.

Inks with mainly the same processing characteristics are here summarized as ink systems.

The ink layer is subsequently dried with dryer 111 before the sheet is transferred to the next printing units 33 and 34. The printing sheet is here printed with an ink of an ink system comprising of other inks for instance inks typically used for offset printing.

The coating is applied next over the entire sheet by the coating plate 81 in the coating tower 4. The coating has the characteristics to react with the ink systems differently physically and/or chemically and to influence through it the degree of gloss in the concerning ink layer divergently. A colorless coating hardening like hybrid ink under ultraviolet light is used in the embodiment. The coating layer is than dried in the dryer 112.

One of the possible requirements for the above-mentioned effect is that the ink systems are differing in their ability of coating resorption from each other. The degree of gloss is reciprocally proportional to the ability for resorption of the ink system to the coating, whereby at ink layers of ink systems with lower ability for resorption more coating retains at their surfaces and at ink layers of ink systems with higher ability for resorption a higher portion is taken by the ink layer. The gloss-determining constituents of the coating are picked up by the ink layer.

The invention is not limited to the above mentioned differences in the ability for resorption of a coating layer. It includes rather all ink systems changing their degree of gloss or their gloss effect in the combined action with the coating layer specifically. Nevertheless drying and/or hardening of the sheet or the printing substrate after printing with additional energy it is not necessary. Other process treatment of the ink layers and/or coating layers are possible in order to obtain the diverging degree of gloss of the final coating layer by physical and/or chemical reactions.

In another embodiment of the invention the process treatment can be eliminated totally or partially. The above mentioned effects are obtained by selection of suitable ink systems and corresponding coating.

1. Method for spot coating on printing substrates in large size printing machines producing a printed image by application of an ink layer on a printing substrate whereby the entire area of printed image is coated by an universally applicable offset plate, using a coating reacting with the ink layers of at least two ink systems and changing the printed image so that diverging areas of gloss degree are created.

2. Method for spot coating on printing substrates according to claim 1 whereby a printed offset plate is used.

3. Method for spot coating on printing substrates according to claim 1 whereby the particular ink system reacts physically and/or chemically with the coating layer.

4. Method for spot coating on printing substrates according to claim 1 whereby the ink systems are treated in the process differently by hardening and/or drying after their application.

5. Method for spot coating on printing substrates according to claim 1 whereby the ink systems are differing in their ability for resorption of coating.

6. Method for spot coating on printing substrates according to claim 1 whereby the degree of gloss is reciprocally proportional to the ability for resorption of the ink system to the coating, whereby at ink layers of ink systems with lower ability for resorption more coating retains at their surfaces and at ink layers of ink systems with higher ability for resorption a higher portion is taken by the ink layer.

7. Method for spot coating on printing substrates according to claim 1 whereby the gloss determining constituents of the coating are resorbed by the ink layer.

8. Method for spot coating on printing substrates according to claim 1 whereby the used coating is colorless.

9. Method for spot coating on printing substrates according to claim 1 whereby one of the ink systems comprises of hybrid ink containing proportional ink hardening under radiation and the other ink system comprises of typical offset ink.

10. Method for spot coating on printing substrates according to claim 1 whereby the coating is hardened by radiation.

11. Method for spot coating on printing substrates according to claim 1 whereby the hybrid ink and the coating are hardened by ultraviolet light.

12. Apparatus to implement the method described in the preceding claims for spot coating on printing substrates whereby a conventional printing machine comprising of at least two printing units for printing of at least ink systems, an optional dryer is allocated to the printing units and a coating unit for the final coating layer is succeeding the printing units.

13. Apparatus according to claim 12 whereby the coating unit is a coating tower with a coating form cylinder, a screened roller and a chamber doctor blade.
